(19) United States
(12) Patent Application Publication
(10) Pub. No.: US 2023/0257651 A1
(43) Pub. Date: Aug. 17, 2023

(54) METHOD OF PREPARING QUANTUM DOT, QUANTUM DOT PREPARED THEREBY, AND ELECTRONIC APPARATUS INCLUDING THE QUANTUM DOT

(71) Applicant: Samsung Display Co., Ltd., Yongin-si (KR)

(72) Inventors: Kawon Pak, Yongin-si (KR); Seungwon Park, Yongin-si (KR); Seunghee Jang, Yongin-si (KR)

(21) Appl. No.: 18/165,210

(22) Filed: Feb. 6, 2023

(30) Foreign Application Priority Data
Feb. 14, 2022 (KR) 10-2022-0019100

(51) Int. Cl. C09K 11/88; C09K 11/08

(52) U.S. Cl. CPC C09K 11/883; C09K 11/0883; B82Y 20/00

(57) ABSTRACT

A method of preparing a quantum dot, a quantum dot prepared thereby, and an electronic apparatus including the quantum dot are provided. The method includes: preparing a first solution containing a first element-containing precursor; a preparing a second solution by mixing the first solution with a second element-containing precursor and a third element-containing precursor; and forming a core by heating the second solution. The first element-containing precursor and the second element-containing precursor each independently includes carbon atoms, wherein a number of carbon atoms included in the first element-containing precursor is greater than a number of carbon atoms included in the second element-containing precursor, wherein the first element includes a Group III element other than gallium (Ga), the second element includes Ga, and the third element includes a Group V element.

### CROSS-REFERENCE TO RELATED APPLICATION

This application claims priority to and the benefit of Korean Patent Application No. 10-2022-0019100, filed on Feb. 14, 2022, in the Korean Intellectual Property Office, the disclosure of which is incorporated by reference herein in its entirety.

### BACKGROUND

### 1. Field

One or more embodiments relate to a method of preparing a quantum dot, a quantum dot prepared thereby, and an electronic apparatus including the quantum dot.

### 2. Description of the Related Art

Quantum dots are nanocrystals of semiconductor materials and exhibit a quantum confinement effect. When reaching an energy excited state by receiving light from an excitation source, quantum dots emit energy by themselves according to a corresponding energy band gap. Here, even in the case of the same materials, a wavelength varies depending on a particle size. Thus, by adjusting the size of quantum dots, light having a desired or suitable wavelength range may be obtained, and quantum dots may exhibit characteristics such as excellent or suitable color purity and high luminescence efficiency. Accordingly, quantum dots may be applicable to one or more suitable devices or apparatuses.

### SUMMARY

Aspects of one or more embodiments are directed toward a method of preparing a quantum dot having excellent or suitable absorbance, a quantum dot prepared thereby, and an electronic apparatus including the quantum dot.

Additional aspects will be set forth in part in the description which follows and, in part, will be apparent from the description, or may be learned by practice of the presented embodiments of the disclosure. According to one or more embodiments, provided is a method of preparing a quantum dot, the method including a first step (e.g., act or task) of preparing a first solution containing a first element-containing precursor a second step of preparing a second solution by mixing the first solution with a second element-containing precursor and a third element-containing precursor, and a third step of forming a core by heating the second solution, wherein the first element-containing precursor and the second element-containing precursor each independently include carbon atoms, and the number of the carbon atoms included in the first element-containing precursor is greater than that of carbon atoms included in the second element-containing precursor, the first element includes a Group III element other than gallium (Ga), the second element includes Ga, and the third element includes a Group V element.

According to one or more embodiments, provided is a quantum dot prepared by the method.

According to one or more embodiments, provided is a quantum including a core and a shell, wherein the core includes a first element, a second element, and a third element, the shell includes a fourth element, a ratio (x/y) of an amount of the second element (x) to an amount of the first element (y) is greater than or equal to about 0.1 and less than or equal to about 0.5, and each of the amount of the first element and the amount of the second element is a value measured by inductively coupled plasma-mass spectrometry.

According to one or more embodiments, provided is an electronic apparatus including the quantum dot.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of a quantum dot according to an embodiment of the present disclosure;

FIG. 2A is a schematic diagram showing a method of preparing a quantum dot suitable in the art, and FIG. 2B is a schematic diagram showing a method of preparing a quantum dot according to an embodiment of the present disclosure;

FIG. 3 is a graph of absorbance according to wavelengths of quantum dots prepared according to Examples 1-1 to 1-3;

FIG. 4 is a graph of absorbance according to wavelengths of quantum dots prepared according to Example 1-1 and Comparative Example 1-1;

FIG. 5 is a graph of absorbance according to wavelengths of quantum dots prepared according to Examples 2-1 to 2-5 and Comparative Example 2-1; and

FIG. 6 is a graph of absorbance according to wavelengths of quantum dots prepared according to Comparative Examples 2-1 to 2-4.

### DETAILED DESCRIPTION

Reference will now be made in more detail to embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described below, by referring to the drawings, to explain aspects of the present description. As used herein, the term “and/or” includes any and all combinations of one or more of the associated listed items. Throughout the disclosure, the expression “at least one of a, b or c”, “at least one selected from a, b, and c”, etc., indicates only a, only b, only c, both (e.g., simultaneously) a and b, both (e.g., simultaneously) a and c, both (e.g., simultaneously) b and c, all of a, b, and c, or variations thereof.

Because the disclosure may have diverse modified embodiments, embodiments are illustrated in the drawings and are described in the detailed description. An effect and a characteristic of the disclosure, and a method of accomplishing these will be apparent when referring to embodiments described with reference to the drawings. The disclosure may, however, be embodied in many different forms and should not be construed as limited to the embodiments set forth herein.

It will be understood that although the terms “first,” “second,” etc. used herein may be used herein to describe one or more suitable components, these components should not be limited by these terms. These components are only used to distinguish one component from another.

An expression used in the singular encompasses the expression of the plural, unless it has a clearly different meaning in the context.

It will be further understood that the terms “includes” and/or “comprises” used herein specify the presence of stated features or elements, but do not preclude the presence or addition of one or more other features or elements. Unless defined otherwise, the term “include” and/or “have” may refer to both (e.g., simultaneously) the case of consisting of features or components described in a specification and the case of further including other components. Further, as used herein, the singular forms “a”, “an” and “the” (e.g., “a quantum dot”, etc.,) are intended to include the plural forms as well, unless the context clearly indicates otherwise.

As used herein, the term “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The term “Group II” used herein may include a Group IIA element and a Group IIB element on the IUPAC periodic table, and examples of the Group II element are zinc (Zn), cadmium (Cd), mercury (Hg), and copernicium (Cn), but are not limited thereto.

The term “Group III” used herein may include a Group IIIA element and a Group IIIB element on the IUPAC periodic table, and examples of the Group III element are aluminum (Al), indium (In), gallium (Ga), titanium (Tl), and nihonium (Nh), but are not limited thereto.

The term “Group V” used herein may include a Group VA element and a Group VB element on the IUPAC periodic table, and examples of the Group V element are nitrogen (N), phosphorus (P), and arsenic (As), but are not limited thereto.

The term “Group VI” used herein may include VIA group elements in the IUPAC Periodic Table of Elements. Examples of the group VI element may include oxygen (O), sulfur (S), selenium (Se), and tellurium (Te), but embodiments are not limited thereto.

In the present specification, the term “weight absorption coefficient” used herein refers to light absorbance of quantum dots with respect to light of a specific wavelength, quantified in a weight ratio, and may be calculated based on the Lambert-Beer Law as shown in Equation 1. The term “weight” of the “weight absorption coefficient” may refer to weights in grams. The weight absorption coefficient may be defined as shown in Equation 1:

$$\text{Weight absorption coefficient} \left(\text{a}\right) \text{=} \text{A} / \text{c} ⋅ \text{L}$$

wherein, in Equation 1, A represents absorbance, c represents a concentration of a sample solution (g/mL), and L represents a length of the sample solution (cm).

The term “quantum dot” used herein refers to a crystal of a semiconductor compound, and may include any material capable of emitting light of one or more suitable emission wavelengths according to the size of the crystal.

An aspect of the present disclosure provides a method of preparing a quantum dot, the method including: a first step (e.g., act or task) of preparing a first solution containing a first element-containing precursor; a second step of preparing a second solution by mixing the first solution with a second element-containing precursor and a third element-containing precursor; and a third step of forming a core by heating the second solution.

The first element-containing precursor and the second element-containing precursor may each independently include carbon atoms, and the number of the carbon atoms included in the first element-containing precursor may be greater than that of carbon atoms included in the second element-containing precursor, the first element may include a Group III element other than gallium (Ga), the second element may include Ga, and the third element may include a Group V element.

In an embodiment, the first element may include indium (In).

In an embodiment, the first element-containing precursor may further include, in addition to the first element, a C₁₄-C₃₀ carboxylate.

For example, the first element-containing precursor may further include, in addition to the first element, tetradecanoate, hexadecanoate, octadecanoate, or any combination thereof.

For example, the first element-containing precursor may be In(octadecanoate)₃.

In an embodiment, the first solution may further include an organic solvent. For example, the organic solvent may include 1-octadecene (ODE), trioctylamine (TOA), trioctylphosphine (TOP), or any combination thereof.

In an embodiment, the second element may be Ga.

In an embodiment, the second element-containing precursor may further include, in addition to the second element, a C₁-C₁₃ carboxylate.

For example, the second element-containing precursor may further include, in addition to the second element, acetate, butanoate, hexanoate, octanoate, decanoate, dodecanoate, or any combination thereof.

For example, the second element-containing precursor may include gallium acetate, gallium butanoate, gallium hexanoate, gallium octanoate, gallium decanoate, gallium dodecanoate, or any combination thereof.

For example, the second element-containing precursor may be Ga(dodecanaote)₃.

In one or more embodiments, the second element-containing precursor may not include (e.g., may exclude) a halide (e.g., may not include any halide).

In an embodiment, the third element may include phosphorus (P).

In an embodiment, the third element-containing precursor may include: nitrogen or a nitrogen-containing compound; phosphorus or a phosphorus-containing compound; or arsenic or an arsenic-containing compound.

For example, the third element-containing precursor may include alkyl phosphine, tristrialkylsilyl phosphine, trisdialkylsilyl phosphine, trisdialkylamino phosphine, arsenic oxide, arsenic chloride, arsenic sulfate, arsenic bromide, arsenic ioidide, nitric oxide, nitric acid, ammonium nitrate, and/or the like.

For example, the third element-containing precursor may be tris(trimethylsilyl)phosphine.

In an embodiment, the method of preparing the quantum dot may further include: a fourth step of forming a shell by heating a fourth solution in which the core and a fourth element-containing precursor are mixed, wherein the fourth element may include a Group II element, a Group VI element, or any combination thereof.

For example, the fourth element may include Zn, Se, S, or any combination thereof.

For example, the fourth element-containing precursor may further include, in addition to the fourth element, a C₁₄-C₃₀ carboxylate.

In one or more embodiments, the fourth element-containing precursor may include: zinc or a zinc-containing compound; cadmium or a cadmium-containing compound; or mercury or a mercury-containing compound; sulfur or a sulfur compound; selenium or a selenium compound; or tellurium or a tellurium compound; or any combination thereof.

For example, the fourth element-containing precursor may include: zinc acetate, dimethyl zinc, diethyl zinc, zinc carboxylate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, cadmium oxide, dimethyl cadmium, diethyl cadmium, cadmium carbonate, cadmium acetate dihydrate, cadmium acetylacetonate, cadmium fluoride, cadmium chloride, cadmium iodide, cadmium bromide, cadmium perchlorate, cadmium phosphide, cadmium nitrate, cadmium sulfate, cadmium carboxylate, mercury iodide, mercury bromide, mercury fluoride, mercury cyanide, mercury nitrate, mercury perchlorate, mercury sulfate, mercury oxide, mercury carbonate, or mercury carboxylate;

sulfur, trialkylphosphine sulfide, trialkenylphosphine sulfide, alkylamino sulfide, alkenylamino sulfide, alkylthiol, selenium, trialkylphosphine selenide, trialkenylphosphine selenide, alkylamino selenide, alkenylamino selenide, trialkylphosphine telluride, trialkenylphosphine telluride, alkylamino telluride, alkenylamino, or telluride; or any combination thereof.

For example, the fourth element-containing precursor may be zinc oleate, trioctylphosphine sulfide, or trioctylphosphine selenide.

In an embodiment, a temperature at which the first step is performed may be greater than or equal to 120° C. and less than or equal to 150° C.

In an embodiment, a temperature at which the second step is performed may be greater than or equal to 20° C. and less than or equal to 120° C. In one or more embodiments, the temperature at which the second step is performed may be greater than or equal to 20° C. and less than or equal to 50° C. In one or more embodiments, the temperature at which the second step is performed may be greater than or equal to 20° C. and less than or equal to 30° C.

In an embodiment, a temperature at which the third step is performed may be greater than or equal to 250° C. and less than or equal to 350° C.

In the method of preparing the quantum dot, the first element-containing precursor and the second element-containing precursor may each independently include carbon atoms, and the number of the carbon atoms included in the first element-containing precursor may be greater than that of carbon atoms included in the second element-containing precursor. Accordingly, the reactivity of each of the first element-containing precursor and the second element-containing precursor with the third element-containing precursor may be adjusted. In an embodiment, the reactivity of the first element with the third element may be high, whereas the reactivity of the second element with respect to the third element may be low. In this embodiment, as the first element-containing precursor includes a large number of carbon atoms, i.e., a ligand with a large number of carbon atoms, steric hindrance increases, and thus the reactivity with the third element-containing precursor may be lowered. Because the second element-containing precursor includes a small number of carbon atoms, i.e., a ligand with a small number of carbon atoms, steric hindrance decreases, and thus the reactivity with the third element-containing precursor may be increased. Therefore, the quantum dot prepared by the method described herein may have excellent or suitable absorbance due to the increased amount of the second element, and accordingly may be used for the preparation of a high-quality electronic device.

Another aspect of the present disclosure provides a quantum dot prepared by the method of preparing the same as described above.

Another aspect of the present disclosure provides a quantum including: a core; and a shell, wherein the core includes a first element, a second element, and a third element, the shell includes a fourth element, a ratio (x/y) of an amount of the second element (x) to an amount of the first element (y) is greater than or equal to about 0.1 and less than or equal to about 0.5, and each of the amount of the first element and the amount of the second element is a value measured by inductively coupled plasma-mass spectrometry.

In an embodiment, the first element and the second element may each independently include a Group III element, but may be different from each other,
the third element may include a Group V element, and
the fourth element may include a Group II element, a Group VI element, or any combination thereof.

For example, the first element may include In.

For example, the second element may include Ga.

For example, the third element may include P.

For example, the fourth element may include Zn, Se, S, or any combination thereof.

In an embodiment, the core may include a Group III-V semiconductor compound.

Examples of the Group III-V compound are: a binary compound, such as GaN, GaP, GaAs, GaSb, AlN, AlP, AlAs, AlSb, InN, InP, InAs, InSb, etc.; a ternary compound, such as GaNP, GaNAs, GaNSb, GaPAs, GaPSb, AlNP, AlNAs, AlNSb, AlPAs, AlPSb, InGaP, InNP, InAlP, InNAs, InNSb, InPAs, InPSb, etc.; a quaternary compound, such as GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, etc.; or any combination thereof. In an embodiment, the Group III-V semiconductor compound may further include a Group II element. Examples of the Group III-V semiconductor compound further including the Group II element are InZnP, InGaZnP, InAlZnP, and/or the like.

In one or more embodiments, the core may include InGaP.

The shell of the quantum dot may act as (e.g., be) a protective layer which prevents (or protects from) chemical denaturation of the core to maintain semiconductor characteristics, and/or as a charging layer which impart electrophoretic characteristics to the quantum dot. The shell may be a single layer or a multi-layer. The interface between the core and the shell may have a concentration gradient in which the concentration of an element existing in the shell decreases toward the center of the core.

In an embodiment, the shell of the quantum dot may be a single layer. Examples of the shell of the quantum dot may be an oxide of metal, metalloid, or non-metal, a semiconductor compound, or a combination thereof. Examples of the oxide of metal, metalloid, or non-metal are: a binary compound, such as SiO₂, Al₂O₃, TiO₂, ZnO, MnO, Mn₂O₃, Mn₃O₄, CuO, FeO, Fe₂O₃, Fe₃O₄, CoO, Co₃O₄, NiO, and/or the like; a ternary compound, such as MgAl₂O₄, CoFe₂O₄, NiFe₂O₄, CoMn₂O₄, and/or the like; or any combination thereof. Examples of the semiconductor compound are: as described herein, a Group II-VI semiconductor compound; a Group III-V semiconductor compound; a Group III-VI semiconductor compound; a Group I-III-VI semiconductor compound; a Group IV-VI semiconductor compound; or any combination thereof. Examples of the semiconductor compound are CdS, CdSe, CdTe, ZnS, ZnSe, ZnTe, ZnSeS, ZnTeS, GaAs, GaP, GaSb, HgS, HgSe, HgTe, InAs, InP, InGaP, InSb, AlAs, AlP, AlSb, or any combination thereof.

In an embodiment, the shell may include a Group II-VI semiconductor compound.

Examples of the Group II-VI semiconductor compound are: a binary compound, such as CdS, CdSe, CdTe, ZnS, ZnSe, ZnTe, ZnO, HgS, HgSe, HgTe, MgSe, MgS, and/or the like; a ternary compound, such as CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and/or the like; a quaternary compound, such as CdZnSeS, CdZnSeTe, CdZnSTe, CdHgSeS, CdHgSeTe, CdHgSTe, HgZnSeS, HgZnSeTe, HgZnSTe, and/or the like; or any combination thereof.

In an embodiment, the weight absorption coefficient of the quantum dot at a wavelength of 450 nm may be greater than or equal to about 300 mL·g⁻¹·cm⁻¹ and less than or equal to about 500 mL·g⁻¹·cm⁻¹.

In an embodiment, the quantum dot may emit green light having a maximum emission wavelength of greater than or equal to about 490 nm and less than or equal to about 550.

In one or more embodiments, the quantum dot may emit visible light other than green light. For example, the quantum dot may emit light having a maximum emission wavelength in a range of about 450 nm to about 490 nm or about 600 nm to about 750 nm. Accordingly, the quantum dot may be designed to emit light having a wavelength of a wide range of color.

The quantum dot may have an emission wavelength in a range of about 1 nm to about 10 mm. For example, the quantum dot may emit UV light, visible light, or IR light.

In an embodiment, a diameter (e.g., size or breadth) of the quantum dot may be, for example, in a range of about 1 nm to about 10 nm. For example, the diameter of the quantum dot may be in a range of about 3 nm to about 10 nm, for example, about 4 nm to about 10 nm, about 5 nm to about 10 nm, or about 6 nm to about 9 nm.

In an embodiment, a full width at half maximum (FWHM) of a PL spectrum of the quantum dot may be less than or equal to about 60 nm, for example, less than or equal to about 55 nm, less than or equal to about 50 nm, or less than or equal to about 40 nm. When the FWHM of the quantum dot is satisfied within the ranges above, the quantum dot may provide excellent or suitable color purity and color reproducibility and an improved viewing angle.

In some embodiments, a form of the quantum dot is not particularly limited, and may be any one commonly used in the art. For example, the quantum dot may be a spherical, pyramidal, multi-arm, or cubic nanoparticle, nanotube, nanowire, nanofiber, or nanoplate particle.

Because the energy band gap may be adjusted by controlling the size of the quantum dot, light having one or more suitable wavelengths may be obtained from an emission layer including quantum dots. Accordingly, by using quantum dots of different sizes, a light-emitting device that emits light of one or more suitable wavelengths may be implemented. In an embodiment, the size of the quantum dots may be selected to emit red light, green light, and/or blue light. In some embodiments, the size of the quantum dots may be configured to emit white light by combining light of one or more suitable colors.

In the quantum dot, a ratio (x/y) of the amount of the second element (x) to an amount of the first element (y) may be greater than or equal to about 0.1 and less than or equal to about 0.5. In a quantum dot prepared by a suitable preparation method in the art, such a ratio x/y is close to 0. For example, it is confirmed that the amount of the second element is increased in the quantum dot of the present disclosure, and thus the quantum dot of the present disclosure may have excellent or suitable absorbance. In some embodiments, when the ratio x/y is less than 0.1, the amount of the second element is small, and thus the absorbance may also decrease. When the ratio x/y is greater than 0.5, due to the excessive amount of the second element, the luminescence efficiency may decrease and the FWHM may increase. Accordingly, a light-emitting device including the quantum dot may be used to manufacture a high-quality electronic apparatus.

The quantum dot may further include: a Group II-VI semiconductor compound; a Group III-V semiconductor compound; a Group III-VI semiconductor compound; a Group I-III-VI semiconductor compound; a Group IV-VI semiconductor compound; a Group IV element or compound; or any combination thereof.

Examples of the Group II-VI semiconductor compound are as defined herein.

Examples of the Group III-V semiconductor compound are as defined herein.

Examples of the Group III-VI semiconductor compound are: a binary compound, such as GaS, GaSe, Ga₂Se₃, GaTe, InS, InSe, In₂S₃, In₂Se₃, InTe, and/or the like; a ternary compound, such as InGaS₃, InGaSe₃, and/or the like; or any combination thereof.

Examples of the Group I-III-VI semiconductor compound are: a ternary compound, such as AgInS, AgInS₂, CuInS, CuInS₂, CuGaO₂, AgGaO₂, AgAlO₂, and/or the like; or any combination thereof.

Examples of the Group IV-VI semiconductor compound are: a binary compound, such as SnS, SnSe, SnTe, PbS, PbSe, PbTe, and/or the like; a ternary compound, such as SnSeS, SnSeTe, SnSTe, PbSeS, PbSeTe, PbSTe, SnPbS, SnPbSe, SnPbTe, and/or the like; a quaternary compound, such as SnPbSSe, SnPbSeTe, SnPbSTe, and/or the like; or any combination thereof.

Examples of the Group IV element or compound are: a single element compound, such as Si, Ge, and/or the like; a binary compound, such as SiC, SiGe, and/or the like; or any combination thereof.

Another aspect of the present disclosure provides an electronic apparatus including the quantum dot. The electronic apparatus may further include a thin-film transistor. For example, the electronic apparatus may further include a thin-film transistor including a source electrode and a drain electrode, wherein the first electrode of a light-emitting device may be electrically connected to the source electrode or the drain electrode. In an embodiment, the electronic apparatus may further include a color filter, a color conversion layer, a touch screen layer, a polarizing layer, or any combination thereof. The electronic apparatus may be the same as described herein.

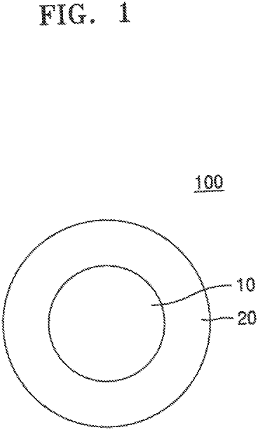

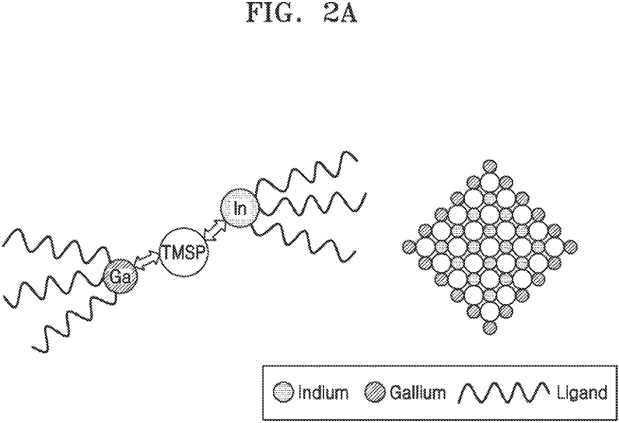

### Description of FIG. 1

FIG. 1 is a schematic view of a quantum dot 100 according to an embodiment of the present disclosure. The quantum dot 100 may include a core 10 and a shell 20.

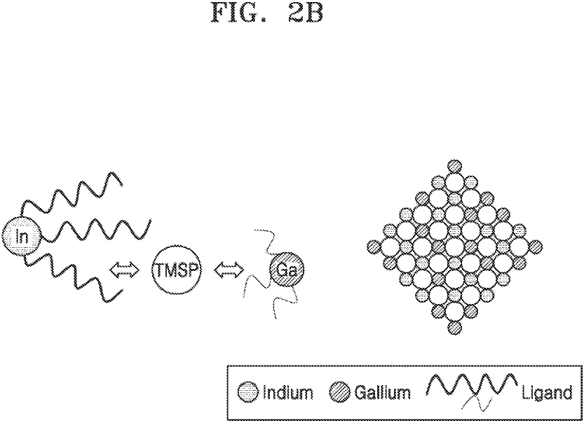

### Description of FIGS. 2A and 2B

FIG. 2A is a schematic diagram showing a method of preparing a suitable quantum dot, and FIG. 2B is a schematic diagram showing the method of preparing the quantum dot according to an embodiment of the present disclosure. In FIGS. 2A and 2B, the first element may each be In, the second element may each be Ga, and the third element-containing precursor may each be tris(trimethylsilyl)phosphine (TMSP).

In FIG. 2A, a ligand of the first element-containing precursor and a ligand of the second element-containing precursor may be identical to each other. Thus, in the quantum dot prepared according to the method described herein, due to the difference in the reactivity, In and P may be bonded to each other while Ga and P may not be easily bonded to each other.

In some embodiments, in FIG. 2B, a ligand of the first element-containing precursor gas a greater number of carbon atoms than a ligand of the second element-containing precursor. Thus, by the balance of the reactivity, not only In and P, but also Ga and P may be bonded to each other.

### Optical Member

Another aspect of the present disclosure provides an optical member including the quantum dot.

The optical member may be, for example, a color conversion member. The color conversion member may include, as described above, quantum dots having excellent or suitable light conversion efficiency, and thus may have excellent or suitable light conversion efficiency.

The color conversion member may include a substrate and a pattern layer formed on the substrate.

The substrate may be a substrate constituting the color conversion member, or may be a region of one or more suitable apparatuses (for example, a display apparatus) in which the color conversion member is located. The substrate may be a glass, silicon (Si), silicon oxide (SiOx), or a polymer substrate, and the polymer substrate may be polyethersulfone (PES) or polycarbonate (PC).

The pattern layer may include quantum dots in the form of a thin film. For example, the pattern layer may be thin-film quantum dots.

The color conversion member including the substrate and the pattern layer may further include a partition wall or a black matrix formed between pattern layers. In some embodiments, the color conversion member may further include a color filter to further improve light conversion efficiency.

The color conversion member may include a red pattern layer capable of emitting red light, a green pattern layer capable of emitting green light, a blue pattern layer capable of emitting blue light, or any combination thereof. The red pattern layer, the green pattern layer and/or the blue pattern layer may be implemented by controlling the components, compositions and/or structure of a nanoparticle in the quantum dots.

For example, the quantum dots included in the color conversion member may absorb first light, and then emit second light that is different from the first light. For example, the quantum dots may absorb blue light, and then emit visible light other than blue light, for example, visible light having a maximum emission wavelength in a range of about 495 nm to about 750 nm. Accordingly, the color conversion member including the quantum dots may be designed to absorb blue light and emit light having a wide color range of wavelength.

In one or more embodiments, the quantum dots included in the color conversion member may be to absorb blue light and then emit green light having a maximum emission wavelength in a range of about 495 nm to about 570 nm. Accordingly, the color conversion member including the quantum dots may realize green light having high luminance and high color purity.

### Electronic Apparatus

Quantum dots may be included in one or more suitable electronic apparatuses. For example, an electronic apparatus including the quantum dots may be a light-emitting apparatus, an authentication apparatus, and/or the like.

The electronic apparatus (for example, a light-emitting apparatus or a display apparatus) may further include, in addition to a light-emitting device, i) a color filter, ii) a color conversion layer, or iii) a color filter and a color conversion layer. The color filter and/or the color conversion layer may be arranged in at least one traveling direction of light emitted from the light-emitting device. For example, the light emitted from the light-emitting device may be blue light or white light. In an embodiment, the light-emitting device may include the quantum dots. In an embodiment, the color conversion layer may include a quantum dot. The quantum dot may be, for example, the quantum dot as described herein.

The electronic apparatus may be applied to one or more suitable displays, light sources, lighting, personal computers (for example, a mobile personal computer), mobile phones, digital cameras, electronic organizers, electronic dictionaries, electronic game machines, medical instruments (for example, electronic thermometers, sphygmomanometers, blood glucose meters, pulse measurement devices, pulse wave measurement devices, electrocardiogram displays, ultrasonic diagnostic devices, or endoscope displays), fish finders, one or more suitable measuring instruments, meters (for example, meters for a vehicle, an aircraft, and a vessel), projectors, and/or the like.

The electronic apparatus and/or any other relevant devices or components according to embodiments described herein may be implemented utilizing any suitable hardware, firmware (e.g. an application-specific integrated circuit), software, or a combination of software, firmware, and hardware. For example, the various components of the apparatus may be formed on one integrated circuit (IC) chip or on separate IC chips. Further, the various components of the apparatus may be implemented on a flexible printed circuit film, a tape carrier package (TCP), a printed circuit board (PCB), or formed on one substrate. Further, the various components of the apparatus may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments.

Hereinafter, methods of preparing quantum dots according to examples will be described in more detail.

### EXAMPLES

### Example 1-1

### 1) Preparation of Core 1-1

Indium acetate (10 mmol), zinc acetate (10 mmol), and stearic acid (also referred to as octadecanoic acid) (50 mmol) were mixed with a solvent, 1-octadecene (50 mL), and the mixed solution was heated under vacuum at 120° C. for 2 hours to prepare a first solution containing In(octadecanoate)₃ (as a first element-containing precursor).

Galium acetate (8 mmol) and lauric acid (also referred to as dodecanoic acid) (24 mmol) were mixed with a solvent, 1-octadecene (50 mL), and the mixed solution was heated under vacuum at 120° C. for 2 hours and then purified to obtain Ga(dodecanaote)₃ (8 mmol)(as a second element-containing precursor). Next, a solution containing the Ga(dodecanaote)₃ (8 mmol) and tris(trimethylsilyl)phosphine (13.9 mmol) (as a third element-containing precursor) was added to the first solution at room to prepare a second solution.

The second solution was heated in a nitrogen atmosphere at 300° C. for 2 minutes, and the reaction temperature was lowered in a nitrogen atmosphere to prepare Core 1-1 (i.e., InGaP).

### 2) Preparation of Quantum Dot 1-1

Core 1-1 was purified using a mixed solution of toluene and acetone, and to Core 1-1 dispersed in toluene, fourth element-containing precursors, such as zinc oleate (26 mmo, trioctylphosphine selenide (10.2 mmol)), and trioctylphosphine sulfide (8 mmol), and trioctylamine, were added. The reaction solution was allowed for a reaction at 320° C. for 1 hour to form a ZnSeS shell, thereby synthesizing Quantum dot 1-1 (InGaP/ZnSeS).

### Examples 1-2 and 1-3

Quantum dots 1-2 and 1-3 were each prepared in substantially the same manner as in Example 1-1, except that the amounts of tris(trimethylsilyl)phosphine were 11.9 mmol and 9.7 mmol, respectively, instead of 13.9 mmol in preparing Core 1-1 of Example 1-1.

### Comparative Example 1-1

### 1) Preparation of Core A

Indium acetate (10 mmol), zinc acetate (10 mmol), gallium acetate (8 mmol), and stearic acid (also referred to as octadecanoic acid) (74 mmol) were mixed with a solvent, 1-octadecene (50 mL), and the mixed solution was heated under vacuum at 120° C. for 2 hours to prepare a cation precursor solution.

The cation precursor solution was then mixed with tris(trimethylsilyl)phosphine (13.9 mmol) in a nitrogen atmosphere at room temperature.

The mixed solution was heated in a nitrogen atmosphere at 300° C. for 2 minutes, and the reaction temperature was lowered in a nitrogen atmosphere to prepare Core A.

### 2) Preparation of Quantum Dot A

A shell of Core A was formed in substantially the same manner as in a process of forming the shell of Core 1-1 according to Example 1, thereby synthesizing Quantum dot A (i.e., InGaP/ZnSeS).

### Evaluation Example 1: Measurement Ga Amount, Absorbance, and Weight Absorption Coefficient

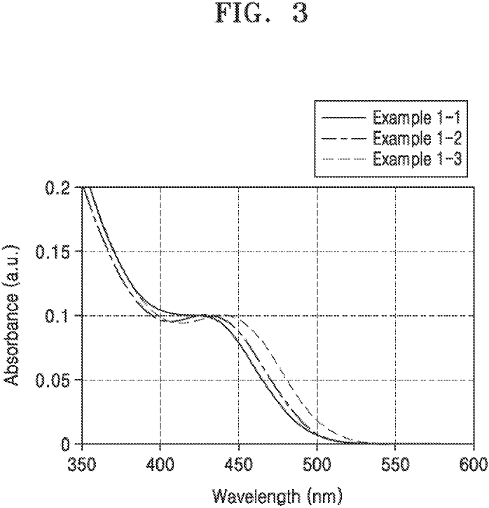

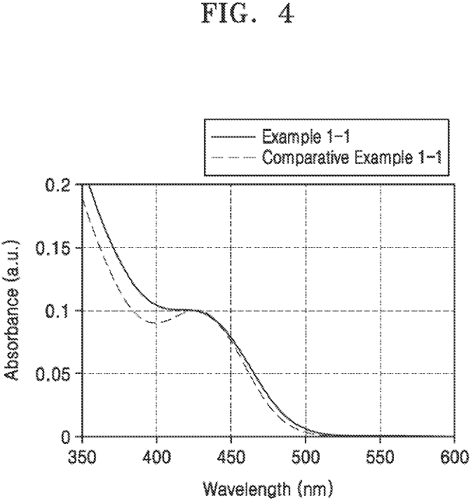

The quantum dots prepared according to Example 1-1 and Comparative Example 1-1 were measured for amounts of each element by inductively coupled plasma-mass spectrometry, and results are shown in Table 1. In addition, to measure a weight absorption coefficient of each of the quantum dots, a Cary 300 Bio UV-Vis spectrophotometer manufactured by Gilent company was used. In more detail, a 10 ppm solution was added to a cuvette having an optical length of 10 mm to measure absorbance units, and accordingly, the weight absorption coefficient (mL·g⁻¹·cm⁻¹) at a wavelength of 400 nm was calculated therefrom according to the Lambert-Beer Law. Results are shown in Table 1. The absorbance according to the wavelengths of the quantum dots are shown in FIGS. 3 and 4.

TABLE 1

| | Core | | | | Quantum dot | | | | | | | Weight absorption coefficient |
|---|---|---|---|---|---|---|---|---|---|---|---|---|
| | In | Ga | Zn | (In+Ga)/P | P | Zn | Ga | In | Se | S | (In+Ga)/P | |
| Comparative Example 1-1 | 1.00 | 0.61 | 0.25 | 1.92 | 1.00 | 27.69 | 0.00 | 1.25 | 5.91 | 16.78 | 1.25 | 286 |
| Example 1-1 | 1.00 | 0.72 | 0.28 | 1.45 | 1.00 | 14.68 | 0.24 | 0.79 | 3.03 | 8.82 | 1.03 | 418 |

Referring to Table 1, the ratio (x/y) of the amount (x) of Ga to the amount (y) in Core A of Comparative Example 1-1 was 0.61, but after the formation of the shell, the ratio x/y in Quantum dot A was 0. For example, it was confirmed that Ga was lost after the formation of the shell. In some embodiments, the ratio x/y in Core 1-1 of Example 1-1 was 0.72, and after the formation of the shell, the ratio x/y in Quantum dot 1-1 was about 0.3. For example, it was confirmed that the quantum dot of Example 1-1 maintained the amount of Ga even after the formation of the shell.

Accordingly, the weight absorption coefficient of Quantum dot A of Comparative Example 1-1 was 286 mL·g⁻¹·cm⁻¹, whereas the weight absorption coefficient of Quantum dot 1-1 of Example 1-1 was 418 mL·g⁻¹·cm⁻¹. As a result, it was confirmed that the absorbance of the quantum dot of Example 1-1 increased by 146 %.

FIG. 3 is a graph of the absorbance according to wavelengths of the quantum dots of Examples 1-1 to 1-3. During the preparation process of the core, as the amount of tris(trimethylsilyl)phosphine increased, the band gap of the alloyed quantum dot increased due to the high energy gap of GaP, and thus the occurrence of blue transition was confirmed.

FIG. 4 is a graph of the absorbance according to wavelengths of the quantum dots of Example 1-1 and Comparative Example 1-1. Referring to FIG. 4, it was confirmed that the quantum dot of Example 1-1 had better absorbance than the quantum dot of Comparative Example 1-1.

### Example 2-1

### 1) Preparation of Core 2-1

Indium acetate (10 mmol), zinc acetate (10 mmol), and stearic acid (also referred to as octadecanoic acid) (50 mmol) were mixed with a solvent, 1-octadecene (50 mL), and the mixed solution was heated under vacuum at 120° C. for 2 hours to prepare a first solution containing In(octadecanoate)₃ (as a first element-containing precursor).

Galium acetate (2.5 mmol) and lauric acid (also referred to as dodecanoic acid) (7.5 mmol) were mixed with a solvent, 1-octadecene (50 mL). The mixed solution was heated under vacuum at 120° C. for 2 hours, and then purified to prepare Ga(dodecanoate)₃ (2.5 mmol) (as a second element-containing precursor). A solution in which Ga(dodecanoate)₃ (2.5 mmol) and tris(trimethylsilyl)phosphine (9.6 mmol) were mixed was added to the first solution in a nitrogen atmosphere at room temperature to prepare a second solution.

The second solution was heated in a nitrogen atmosphere at 300° C. for 2 minutes, and the reaction temperature was lowered in a nitrogen atmosphere to prepare Core 2-1 (i.e., InGaP).

### 2) Preparation of Quantum Dot 2-1

A shell (i.e., ZnSeS) was formed in substantially the same manner as in the preparation of Quantum dot 1-1 of Example 1-1 to form Quantum dot 2-1 (i.e., InGaP/ZnSeS).

### Examples 2-2 to 2-5

Quantum dots 2-2 to 2-5 were each prepared in substantially the same manner as in Example 2-1, except that the amounts of gallium acetate were 2.0 mmol, 1.5 mmol, 1.0 mmol, and 0.8 mmol, respectively, instead of 2.5 mmol in preparing Core 2-1 of Example 2-1.

### Comparative Example 2-1

Quantum dot B-1 was prepared in substantially the same manner as in Example 2-1, except that the amount of gallium acetylacetonate was 0 mmol instead of 2.5 mmol in preparing Core 2-1 of Example 2-1.

### Comparative Examples 2-2 to 2-4

Quantum dots B-2 to B-4 were each prepared in substantially the same manner as in Example 2-1, except that 2.5 mmol, 1 mmol, and 0.25 mmol of GaCl₃ were used, respectively, instead of 2.5 mmol of gallium acetate in preparing Core 2-1 of Example 2-1.

### Evaluation Example 2: Measurement of Absorbance

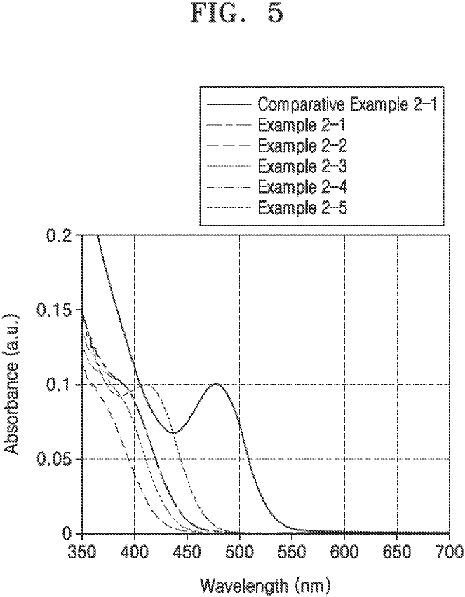

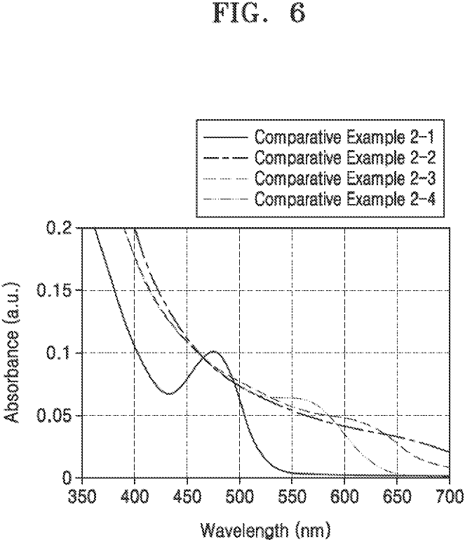

By using the same equipment as in Evaluation Example 1, the absorbance according to the wavelengths of the quantum dots of Examples 2-1 to 2-5 and Comparative Examples 2-1 to 2-4 was measured, and results are shown in FIGS. 5 and 6.

FIG. 5 is a graph of the absorbance according to wavelengths of the quantum dots of Example 2-1 to 2-5 and Comparative Example 2-1. Referring to FIG. 5, as the amount of Ga in the quantum dot increased, the band gap of the alloyed quantum dot increased due to the high energy gap of GaP, and thus the occurrence of blue transition was confirmed.

FIG. 6 is a graph of the absorbance according to wavelengths of the quantum dots of Comparative Examples 2-1 to 2-4. The quantum dots of Comparative Examples 2-2 to 2-4 were each prepared with a Ga precursor that did not include a carbon atom. Referring to FIG. 6, it was confirmed that, unlike the quantum dots of the present disclosure, the quantum dots of Comparative Examples 2-2 to 2-4 were more likely to occur the red-shift as the amount of Ga increased. For example, it was confirmed that, when the precursor (e.g., the second element-containing precursor) did not include a carbon atom, the second element (e.g., Ga) was not bound with the quantum dot and did not form an alloy with the third element (e.g., P).

According to the one or more embodiments, a quantum dot prepared according to a method of preparing the same has excellent or good absorbance, and thus an electronic apparatus including the quantum dot may have improved color reproducibility.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope as defined by the following claims and equivalents thereof.

What is claimed is:

1. A method of preparing a quantum dot, the method comprising:
preparing a first solution comprising a first element-containing precursor;
preparing a second solution by mixing the first solution with a second element-containing precursor and a third element-containing precursor; and
forming a core by heating the second solution,
wherein the first element-containing precursor and the second element-containing precursor each independently comprises carbon atoms, and a number of carbon atoms included in the first element-containing precursor is greater than a number of carbon atoms included in the second element-containing precursor, and
wherein the first element comprises a Group III element other than gallium (Ga), the second element comprises Ga, and the third element comprises a Group V element.

2. The method of claim 1, wherein the first element comprises indium (In).

3. The method of claim 1, wherein the first element-containing precursor further comprises a C₁₄-C₃₀ carboxylate.

4. The method of claim 1, wherein the first element-containing precursor further comprises tetradecanoate, hexadecanoate, octadecanoate, or a combination thereof.

5. The method of claim 1, wherein the second element-containing precursor further comprises a C₁-C₁₃ carboxylate.

6. The method of claim 1, wherein the second element-containing precursor further comprises acetate, butanoate, hexanoate, octanoate, decanoate, dodecanoate, or a combination thereof.

7. The method of claim 1, wherein the second element-containing precursor does not comprise any halide.

8. The method of claim 1, further comprising forming a shell by heating a fourth solution in which the core and a fourth element-containing precursor are mixed,
wherein the fourth element comprises a Group II element, a Group VI element, or a combination thereof.

9. The method of claim 5, wherein the fourth element-containing precursor further comprises a C₁₄-C₃₀ carboxylate.

10. The method of claim 1, wherein the first solution is prepared at a temperature greater than or equal to about 120° C. and less than or equal to about 150° C.

11. The method of claim 1, wherein the second solution is prepared at a temperature greater than or equal to about 20° C. and less than or equal to about 120° C.

12. The method of claim 1, wherein the core is formed by heating the second solution to a temperature greater than or equal to about 250° C. and less than or equal to about 350° C.

13. A quantum dot prepared by the method of claim 1.

14. A quantum dot comprising:
a core; and
a shell,
wherein the core comprises a first element, a second element, and a third element,
wherein the shell comprises a fourth element,
wherein a ratio (x/y) of an amount of the second element (x) to an amount of the first element (y) is greater than or equal to about 0.1 and less than or equal to about 0.5, and
wherein each of the amount of the first element and the amount of the second element is a value measured by inductively coupled plasma-mass spectrometry.

15. The quantum dot of claim 14, wherein the first element and the second element each independently comprise a Group III element, and the first element and the second element are different from each other,
wherein the third element comprises a Group V element, and
wherein the fourth element comprises a Group II element, a Group VI element, or a combination thereof.

16. The quantum dot of claim 14, wherein the second element comprises gallium (Ga).

17. The quantum dot of claim 14, wherein the shell is a single layer.

18. The quantum dot of claim 14, wherein a weight absorption coefficient of the quantum dot for a wavelength of 450 nm is greater than or equal to about 300 mL·g⁻¹·cm⁻¹ and less than or equal to about 500 mL·g⁻¹·cm⁻¹.

19. The quantum dot of claim 14, wherein the quantum dot is to emit green light having a maximum emission wavelength greater than or equal to about 490 nm and less than or equal to about 550 nm.

20. An electronic apparatus comprising the quantum dot of claim 15.
